(19) United States
(12) Patent Application Publication
(10) Pub. No.: US 2004/0142189 A1
(43) Pub. Date: Jul. 22, 2004

(54) Powder coated rotor

(76) Inventors: Volker Karl Ottmar Borschel, Tubingen (DE); Hubert Herrmann, Reutlingen (DE); Gert Kramer, Stuttgart (DE)

Correspondence Address: Lainie E. Parker, Akzo Nobel Inc., Intellectual Property Department, 7 Livingstone Avenue, Dobbs Ferry, NY, 10522, US

(21) Appl. No.: 10/755,532

(22) Filed: Jan. 12, 2004

Related U.S. Application Data
(62) Division of application No. 10/096,807, filed on Mar. 13, 2002.
(60) Provisional application No. 60/290,579, filed on May 11, 2001.

(30) Foreign Application Priority Data
Mar. 14, 2001 (EP) 01200960.1

(51) Int. Cl. B32B 33/00

(52) U.S. Cl. 428/457

(57) ABSTRACT

Rotor, stator, or field coil in an electrical motor or generator, a toroid or a toroidal tape core coated with a powder coating obtained by curing a thermosetting powder coating composition comprising an epoxy-terminated polyoxazolidone resin and a curing agent for the resin. The polyoxazolidone resin can be the reaction product of a diisocyanate selected from the group consisting of 1,6-hexamethylene diisocyanate, 2,6-hexahydrotoluylene diisocyanate, and 4,4′-diphenylmethane diisocyanate, with a diepoxide selected from the group consisting of a diglycidyl ether of bisphenol A and a diglycidyl ether of novolac.

This application claims priority of European Patent Application No. 01200960.1, filed Mar. 14,2001 and U.S. Ser. No. 60/290,579, filed May 11, 2001.

### BACKGROUND OF THE INVENTION

The present invention relates to a powder coated rotor which is used in an electrical motor or generator. Such a rotor, which can also be referred to as an armature, is the part that acts as support for the coil windings in the electrical motor or generator.

When an electrical motor or generator is in operation, in addition to movement of the motor, it will also generate heat. This heat causes all parts in the motor to expand, in particular the coils that are wound around the rotor. When the motor is switched off, it cools down again and the heated parts shrink. During the lifetime of the motor, this heat cycle is repeated very often.

To prevent electrical contact between the rotor and the coil, both are coated with an insulating material, normally a coating.

In the heat cycle, the coils close to the rotor shift somewhat with respect to the surface of the rotor and in view of the tension exerted on the coil to keep it attached to the rotor, this movement of the coil causes abrasion of the coated rotor. Once the coating on the rotor has been worn away to a large extent, short circuiting will occur and the rotor can no longer be used.

It was found that in addition to good adhesion to the surface of the rotor, the coating also needs to have a high cut-through resistance to ensure that a rotor for an electrical motor or generator will have a long lifetime. In addition, it was found that the coating can also be used to coat the stator or field coil of an electrical motor or generator or a toroid or toroidal tape core.

When coating metal articles with a somewhat irregular shape, such as rotors for electrical motors or generators, it is very advantageous to use a powder coating. In addition to the well-known advantages of powder coatings as pollution-free, energy-, resource-, and labour-saving products, in the case of irregularly shaped metal objects the use of powder coatings also enables the application of a coating layer having a uniform thickness and a good edge coverage.

The use of powder coatings for the coating of rotors is known in the art. In view of their good cut-through resistance, nowadays anhydride-containing powder coating compositions are used, e.g., Resicoat RT ex Akzo Nobel. However, for some applications the use of anhydride-containing materials is not preferred in view of the health and safety risks with their use. Further, it was found that the long-term storage stability of these compositions could be improved. Long-term stability tests are based on heat resistance tests, melting points, DSC scans, and roughness profiles of the applied and cured compositions, since the properties of the applied and cured coating will deteriorate when the stored composition is no longer stable.

In U.S. Pat. No. 5,449,737 a urethane-modified epoxy resin coating composition is disclosed. Nothing is said about the storage stability of this coating composition or about the cut-through resistance of the coating. The coating compositions are not used to coat the rotor of an electrical motor or generator.

In U.S. Pat No. 4,923,910 an anhydride-free epoxy powder coating is disclosed that is used to fix the rotor coil of motors and generator to the rotor core. In this publication, the powder coating is used as a kind of adhesive for the coil. Nothing is said about the storage stability of this coating composition or about the cut-through resistance of the coating. The coating compositions are not used to coat the rotor surface. Articles coated with the powder coating compositions disclosed in this publication show an inferior cut-through resistance compared to the articles according to the present invention.

Now a powder coating composition has been found which has a good storage stability, is anhydride-free, and because of its high cut-through resistance is also very suitable for use as a coating for rotors for electrical motors or generators. This composition is a thermosetting powder coating composition comprising an epoxy-terminated polyoxazolidone resin and a curing agent for the resin.

In EP 0 113 575 a polyoxazolidone powder coating composition is disclosed. It is said that the composition can be used for coating metal substrates. Nothing is said about the storage stability of this coating composition or about the cut-through resistance of the coating. No reference is made to the use of this composition for coating the rotor of an electrical motor or generator.

In U.S. Pat. No. 4,304,818 a method for producing an insulated winding for electric rotating machines is disclosed. A plurality of layers of a sheet-form insulating material is wrapped around a winding conductor. The layers are impregnated with a solventless varnish comprising a polyepoxide and an organic polyisocyanate. The varnish is cured in the presence of a catalyst for forming isocyanurate rings and oxazolidone rings. The pot life of the impregnating varnish is short when the catalyst is added. Therefore, the layers are preferably impregnated with dissolved catalyst, followed by impregnation of the resin. This document does not disclose the use of a powder coating. Further, it does not disclose the use of an epoxy-terminated polyoxazolidone resin.

In GEC Alsthom Technical Review (1990) October, N. 3, Paris, FR, pages 15-21, an insulation system for traction motors operating at elevated temperature is disclosed. Insulation is realised by impregnating a mica-based tape with a polyisocyanate comprising resin and a bonding agent. The rigidity and thermostability of the cured polyisocyanate comprising resin are determined by adding epoxy resin and catalyst to the unpolymerised polyisocyanate comprising resin. The resulting macromolecular structure comprises oxazolidone chains. This document does not disclose the use of a powder coating. Further, it does not disclose the use of an epoxy-terminated polyoxazolidone resin as starting material.

### SUMMARY OF THE INVENTION

The present invention relates to a rotor for use in an electrical motor or generator coated with a powder coating wherein the powder coating is obtained by curing a thermosetting powder coating composition comprising an epoxy-terminated polyoxazolidone resin and a curing agent for the resin.

The invention further relates to the use of a thermosetting powder coating composition comprising an epoxy-terminated polyoxazolidone resin and a curing agent for the resin as a coating for a rotor in an electrical motor or generator.

### DETAILED DESCRIPTION OF THE INVENTION

The epoxy-terminated polyoxazolidone resin that can be used according to the present invention can be obtained by reacting a stoichiometric excess of a diepoxide with a diisocyanate. Preferably, the reaction conditions are chosen such that a low-molecular weight, epoxy-terminated polyoxazolidone resin is obtained.

Epoxy resins that can be used in the preparation of an epoxy-terminated polyoxazolidone include diglycidyl ethers of aromatic, aliphatic, cylcoaliphatic or heterocyclic compounds, for example, diglycidyl ethers of bisphenol A, diglycidyl ethers of hydrogenated bisphenol A, diglycidyl ethers of bisphenol F, diglycidyl ethers of novolacs, or diglycidyl ethers of polyglycols. Examples of commercially available suitable epoxy resins are EPON 828, EPON 825, DER 330, DER 331, DER 332, DER 337, and DEN 431.

Isocyanates that can be used in the preparation of an epoxy-terminated polyoxazolidone include isocyanates that can be represented by the formula R—(NCO)ₖ, wherein k is 2 and R represents a divalent aliphatic hydrocarbon group having 2 to 18 carbon atoms, a divalent cycloaliphatic hydrocarbon group having 5 to 15 carbon atoms, a divalent araliphatic hydrocarbon group having 7 to 15 carbon atoms, or a divalent aromatic hydrocarbon group having 6 to 15 carbon atoms. Examples of organic diisocyanates which are particularly suitable include ethylene diisocyanate, 1,3-propylene diisocyanate, 1,4-tetramethylene diisocyanate, 1,6-hexamethylene diisocyanate (HMDI), 2,2,4-trimethyl-1,6-hexamethylene diisocyanate, 2-methyl-1,5-diisocyanate pentane, 2-ethyl-1,4-diisocyanate butane, 1,12-dodecamethylene diisocyanate, cyclohexane-1,3- and -1,4-diisocyanate, 1-isocyanato-2-isocyanatomethyl cyclopentane, isophorone diisocyanate (IPDI), bis-(4-isocyanatocyclohexyl)-methane, 2,4′-dicyclohexylmethane diisocyanate, 1,3- and 1,4-bis(isocyanatomethyl)-cyclohexane, bis-(4-isocyanato-3-methyl-cyclohexyl)-methane, 1-methyl-2,4-diisocyanato cyclohexane, 1-isocyanato-1-methyl-4(3)-isocyanatomethyl cyclohexane, xylene diisocyanate, 1-methyl-2,4-diisocyanato benzene, α, α, α′, α′-tetramethyl -1,3- and -1,4-xylylene diisocyanate, 2,4- and 2,6-hexahydrotoluylene diisocyanate (TDI), 1,3- and 1,4-phenylene diisocyanate, 2,4- and 2,6-toluylene diisocyanate, 2,4- and 4,4′-diphenylmethane diisocyanate (MDI), 1,5-diisocyanato naphthalene, norbornane diisocyanate, and mixtures thereof.

Preferably, MDI, TDI, or HMDI are used in the preparation of the epoxy-terminated polyoxazolidone.

Preference is given to polyoxazolidones having an epoxy equivalent weight in the range of 250 to 4000 that can be prepared by reacting diepoxide and diisocyanate reactants in a ratio of epoxide equivalents to isocyanate equivalents of 5:1 to 1.1:1, preferably in the range of 3:1 to 1.2:1.

A condensation catalyst can be used in the reaction to form the polyoxazolidones. Such catalysts include those conventionally used for these types of reactions between epoxides and isocyanates, such as quaternary ammonium halides, tertiary amines, lithium halides, lithium halide-phosphonium oxide complexes, n-butoxy lithium, dialkyl zinc, organozinc chelate compounds, trialkyl aluminium, and dibutyltin dilaurate.

The reaction can be carried out in a solvent, for example, in lower alkanols or dimethylformamide at a temperature in the range of 75 to 200° C.

The powder coating composition used according to the present invention further comprises a curing agent for the epoxy-terminated polyoxazolidone resin. Such curing agents are well-known in the art and include polyamines, polyamides, polyaminoamides, polyphenols, polymeric thiols, polycarboxylic acids, polyols, imidazoles, tertiary amines, and quaternary ammonium halides. These last three curing agents can also act as an accelerator for the curing reactions. Examples of imidazoles that can be used as curing agent and curing accelerator include 2-styrylimidazole, 1-benzyl -2-methylimidazole, 2-methylimidazole, and 2-butylimidazole.

The powder coating composition can further comprise fillers and/or additives to improve the properties of the coating, such as stabilisers, antioxidants, levelling agents, anti-settling agents, matting agents, rheology modifiers, flexibility agents, surface-active agents, UV light absorbers, light stabilisers, amine synergists, waxes, or adhesion promoters. Further, the coating composition can comprise one or more pigments.

In addition to the resin components mentioned above, the coating composition can also comprise additional resins, such as 0-30, preferably 5-20, percent by weight of an epoxy resin or a mixture of epoxy resins, such as DER 663, DER 664, DR 667, or 0-30, preferably 5-20, percent by weight of an epoxy novolac or a mixture of epoxy novolacs, such as DER 642, DER 672, Araldit ECN1299 or Araldit ECN9699.

In a preferred embodiment the powder coating composition used according to the present invention comprises:

30-90, preferably 40-50, percent by weight of the powder coating composition of a polyoxazolidone resin or a mixture of polyoxazolidone resins;

0.1-40, preferably 5-15, percent by weight of the powder coating composition of a curing agent or a mixture of curing agents;

0.1-50 percent by weight of the powder coating composition of an additive or a mixture of additives and/or a filler or a mixture of fillers.

The powder coating composition can be made by any process wherein all ingredients of the composition are uniformly mixed. For example, the composition can be prepared by intimately mixing the ingredients in an extruder at a temperature above the softening point of the film forming polymer(s), but below the temperature at which significant pre-reaction would occur. The extrudate is usually rolled into a flat sheet, allowed to cool, and broken down into small particles, for example by grinding. Normally, the powder coating particles should have a size below 300 μm, preferably an average size in the range of 100 to 200 μm.

The powder coating can be applied to the rotor by any known powder coating process. Fluidised bed sintering, electrostatic powder coating, or an electrostatic fluidised bed process is preferred. For the coating of a rotor with a powder coating composition comprising an epoxy-terminated polyoxazolidone resin the electrostatic fluidised bed process is preferred. In such a process the rotor is normally heated to a temperature in the range of 180-260° C. Normally the coating is applied in a film thickness in the range of 250 to 500 μm.

The rotor coated with a thermosetting powder coating composition comprising an epoxy-terminated polyoxazolidone resin and a curing agent for the resin can be used in all types of electrical motors or generators. For example, the coated rotor can be used in small-size electrical motors in household and automotive appliances, but it can also be used in larger-size electrical motors or generators or drilling machines. The thermosetting powder coating composition comprising an epoxy-terminated polyoxazolidone resin can also be used for coating field coils, stators, toroids, or toroidal tape cores.

The invention will be elucidated with reference to the following examples. These are intended to illustrate the invention but are not to be construed as limiting in any manner the scope thereof.

### EXAMPLES

### Example 1

A powder coating composition a density of 1.65-1.75 g/cm³ and less than 0.5 wt.% of particles with a size above 200 μm was prepared by mixing the following compounds:

35-45 pbw of a polyoxazolidone resin (reaction product of Bisphenol A diglycidylether and MDI),

5-15 pbw of a phenolic hardener,

<1 pbw of an imidazole, and

45-55 pbw of additives and fillers. This powder coating composition was applied to a rotor in a fluidised bed process and cured at a temperature in the range of 200-240° C.

The obtained coated rotor was coated with a smooth film with a thickness in the range of 250-500 μm. The film had a gloss (measured in accordance with DIN 67530) of 80-100 units, an impact resistance (measured in accordance with DIN 30671) of 10 Joule, a hardness (measured in accordance with DIN 53153) >100, and an edge coverage >40%, a breakdown voltage >30 kV/mm, and a high cut-through resistance at a temperature above 300° C.

### Example 2

The storage stability of a thermosetting powder coating composition comprising an epoxy-terminated polyoxazolidone resin and a curing agent for the resin as prepared in Example 1 was compared to the stability of a commercially available anhydride-containing thermosetting powder coating composition.

Freshly prepared samples of both coatings were applied to a rotor and cured to a smooth coating film. A part of these samples was stored at 23° C. and applied to a rotor after 6 months'storage. The 50% cut-through temperature, the melting point (Tₘ), the glass transition temperature (DSC T_{g1}), and the roughness of the cured coating film of the samples were measured. The results are presented in the table below.

| | Example 1 | | Anhydride powder coating | |
|---|---|---|---|---|
| | | 6 months at | | 6 months |
| | Fresh powder | 23° C. | Fresh powder | at 23° C. |
| 50% cut | 300° C. | 300° C. | 310° C. | 260° C. |
| through | | | | |
| temperature | | | | |
| Tₘ | 99° C. | 99° C. | 84° C. | 98° C. |
| DSC T_{g1} | 69° C. | 69° C. | 63° C. | 73° C. |
| Roughness | 5 μm | 5 μm | 2 μm | >30 μm |

The results above clearly show that the properties of the anhydride-containing powder coating composition deteriorate when the composition is stored for some time. The composition comprising an epoxy-terminated polyoxazolidone resin shows very good properties even after storage for a longer period of time.

1. Rotor, stator, or field coil for use in an electrical motor or generator, a toroid or a toroidal tape core coated with a powder coating, wherein the powder coating is obtained by curing a thermosetting powder coating composition comprising an epoxy-terminated polyoxazolidone resin and a curing agent for the resin.

2. Rotor, stator, field coil, toroid or toroidal tape core according to claim 1 wherein the powder coating composition comprises 30-90% by weight of the powder coating composition of an epoxy-terminated polyoxazolidone resin and 0.1-40% by weight of the powder coating composition of a curing agent for the resin.

3. Rotor, stator, field coil, toroid or toroidal tape core according to claim 1 wherein the powder coating composition comprises an epoxy-terminated polyoxazolidone resin obtained by reacting an diepoxide with 1,6-hexamethylene diisocyanate, 2,6-hexahydrotoluylene diisocyanate or 4,4′-diphenylmethane diisocyanate.

4. Rotor, stator, field coil, toroid or toroidal tape core according to claim 1 wherein the powder coating composition comprises an epoxy-terminated polyoxazolidone resin obtained by reacting a diisocyanate with a diglycidyl ether of bisphenol A or a diglycidyl ether of novolac.

5. Rotor, stator, field coil, toroid or toroidal tape core according to claim 1 wherein the powder coating composition comprises an epoxy-terminated polyoxazolidone resin obtained by reacting a diisocyanate selected from the group consisting of 1,6-hexamethylene diisocyanate, 2,6-hexahydrotoluylene diisocyanate, and 4,4′-diphenylmethane diisocyanate with a diepoxide selected from the group consisting of a diglycidyl ether of bisphenol A and a diglycidyl ether of novolac.

6. Rotor, stator, field coil, toroid or toroidal tape core according to claim 2 wherein the powder coating composition comprises an epoxy-terminated polyoxazolidone resin obtained by reacting an diepoxide with 1,6-hexamethylene diisocyanate, 2,6-hexahydrotoluylene diisocyanate or 4,4′-diphenylmethane diisocyanate.

7. Rotor, stator, field coil, toroid or toroidal tape core according to claim 2 wherein the powder coating composition comprises an epoxy-terminated polyoxazolidone resin obtained by reacting a diisocyanate with a diglycidyl ether of bisphenol A or a diglycidyl ether of novolac.

8. Rotor, stator, field coil, toroid or toroidal tape core according to claim 3 wherein the powder coating composition comprises an epoxy-terminated polyoxazolidone resin obtained by reacting a diisocyanate with a diglycidyl ether of bisphenol A or a diglycidyl ether of novolac.

9. Rotor, stator, field coil, toroid or toroidal tape core according to claim 6 wherein the powder coating composition comprises an epoxy-terminated polyoxazolidone resin obtained by reacting a diisocyanate with a diglycidyl ether of bisphenol A or a diglycidyl ether of novolac.

10. Rotor, stator, field coil, toroid or toroidal tape core according to claim 2 wherein the powder coating composition comprises an epoxy-terminated polyoxazolidone resin obtained by reacting a diisocyanate selected from the group consisting of 1,6-hexamethylene diisocyanate, 2,6-hexahydrotoluylene diisocyanate, and 4,4′-diphenylmethane diisocyanate with a diepoxide selected from the group consisting of a diglycidyl ether of bisphenol A and a diglycidyl ether of novolac.

11. Rotor, stator, field coil, toroid or toroidal tape core according to claim 3 wherein the powder coating composition comprises an epoxy-terminated polyoxazolidone resin obtained by reacting a diisocyanate selected from the group consisting of 1,6-hexamethylene diisocyanate, 2,6-hexahydrotoluylene diisocyanate, and 4,4′-diphenylmethane diisocyanate with a diepoxide selected from the group consisting of a diglycidyl ether of bisphenol A and a diglycidyl ether of novolac.

12. Rotor, stator, field coil, toroid or toroidal tape core according to claim 4 wherein the powder coating composition comprises an epoxy-terminated polyoxazolidone resin obtained by reacting a diisocyanate selected from the group consisting of 1,6-hexamethylene diisocyanate, 2,6-hexahydrotoluylene diisocyanate, and 4,4′-diphenylmethane diisocyanate with a diepoxide selected from the group consisting of a diglycidyl ether of bisphenol A and a diglycidyl ether of novolac.

13. Rotor, stator, field coil, toroid or toroidal tape core according to claim 6 wherein the powder coating composition comprises an epoxy-terminated polyoxazolidone resin obtained by reacting a diisocyanate selected from the group consisting of 1,6-hexamethylene diisocyanate, 2,6-hexahydrotoluylene diisocyanate, and 4,4′-diphenylmethane diisocyanate with a diepoxide selected from the group consisting of a diglycidyl ether of bisphenol A and a diglycidyl ether of novolac.

14. Rotor, stator, field coil, toroid or toroidal tape core according to claim 7 wherein the powder coating composition comprises an epoxy-terminated polyoxazolidone resin obtained by reacting a diisocyanate selected from the group consisting of 1,6-hexamethylene diisocyanate, 2,6-hexahydrotoluylene diisocyanate, and 4,4′-diphenylmethane diisocyanate with a diepoxide selected from the group consisting of a diglycidyl ether of bisphenol A and a diglycidyl ether of novolac.

15. Rotor, stator, field coil, toroid or toroidal tape core according to claim 8 wherein the powder coating composition comprises an epoxy-terminated polyoxazolidone resin obtained by reacting a diisocyanate selected from the group consisting of 1,6-hexamethylene diisocyanate, 2,6-hexahydrotoluylene diisocyanate, and 4,4′-diphenylmethane diisocyanate with a diepoxide selected from the group consisting of a diglycidyl ether of bisphenol A and a diglycidyl ether of novolac.

16. Rotor, stator, field coil, toroid or toroidal tape core according to claim 9 wherein the powder coating composition comprises an epoxy-terminated polyoxazolidone resin obtained by reacting a diisocyanate selected from the group consisting of 1,6-hexamethylene diisocyanate, 2,6-hexahydrotoluylene diisocyanate, and 4,4′-diphenylmethane diisocyanate with a diepoxide selected from the group consisting of a diglycidyl ether of bisphenol A and a diglycidyl ether of novolac.

17. Method of using a powder coating composition comprising an epoxy-terminated polyoxazolidone resin and a curing agent for the resin, the method comprising coating a rotor, stator, or field coil in an electrical motor or generator, a toroid or a toroidal tape core with the coating composition.

18. Method according to claim 17 wherein the powder coating composition comprises 30-90% by weight of the powder coating composition of an epoxy-terminated polyoxazolidone resin and 0.1-40% by weight of the powder coating composition of a curing agent for the resin.
